(19) United States
(12) Patent Application Publication
(10) Pub. No.: US 2023/0106312 A1
(43) Pub. Date: Apr. 6, 2023

(54) LOW VISCOSITY POLISH SYSTEMS FOR ROBOTIC REPAIR OPERATIONS

(71) Applicant: 3M INNOVATIVE PROPERTIES COMPANY, St. Paul, MN (US)

(72) Inventors: Aaron K. Nienaber; Christie L. Vitale, Hudson, WI (US); Grayce T. Huberty, Cottage Grove, MN (US); Paul Larking, Staffordshire (GB)

(21) Appl. No.: 17/904,810

(22) PCT Filed: Feb. 15, 2021
(86) PCT No.: PCT/IB2021/051246

§ 371 Date: Aug. 23, 2022

Related U.S. Application Data
(60) Provisional application No. 62/981,062, filed on Feb. 25, 2020.

(51) Int. Cl. B24B 57/02; B24B 19/26

(52) U.S. Cl. CPC B24B 57/02; B24B 19/26

(57) ABSTRACT

A low viscosity polish kit for a robotic repair unit. The kit includes a sealed container containing a low viscosity polish. The sealed container has a coupling mechanism. The kit also includes a connector configured to couple to the coupling mechanism, on a first end, and to a dispenser of a robotic repair unit, on a second end. The sealed container and the connector are single-use articles.

### BACKGROUND

Clear coat repair is one of the last operations to be automated in the automotive original equipment manufacturing (OEM) sector. Techniques are desired for automating this process as well as other paint applications (e.g., primer sanding, clear coat defect removal, clear coat polishing, etc.) amenable to the use of abrasives and/or robotic inspection and repair.

Prior efforts to automate the detection and repair of paint defects include the system described in U.S. Pat. Publication No. 2003/0139836, which discloses the use of electronic imaging to detect and repair paint defects on a vehicle body. The system references the vehicle imaging data against vehicle CAD data to develop three-dimensional paint defect coordinates for each paint defect. The paint defect data and paint defect coordinates are used to develop a repair strategy for automated repair using a plurality of automated robots that perform a variety of tasks including sanding and polishing the paint defect.

### SUMMARY

A low viscosity polish kit for a robotic repair unit. The kit includes a sealed container containing a low viscosity polish. The sealed container has a coupling mechanism. The kit also includes a connector configured to couple to the coupling mechanism, on a first end, and to a dispenser of a robotic repair unit, on a second end. The sealed container and the connector are single-use articles.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIGS. 1A and 1B are a schematic of a robotic paint repair system in which embodiments of the present invention are useful.

FIGS. 2A and 2B illustrate schematics of paint repair robotic components which may be useful in embodiments of the present invention.

FIG. 3 illustrates a method of using a self-contained fluid dispensing system in accordance with embodiments herein.

FIG. 4 illustrates a method of replacing components of a self-contained fluid dispensing system in accordance with embodiments herein.

FIG. 5 illustrates a robotic repair unit in accordance with embodiments herein.

FIG. 6 illustrates a replacement kit for a self-contained fluid dispensing system in accordance with embodiments herein.

FIGS. 7-8 illustrate atomized polish as described in the Examples herein.

### DETAILED DESCRIPTION

Recent advancements in imaging technology and computational systems has made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow subsequent automated spot repair.

As defect detection and classification techniques improve, the ability to automate the repair of detected defects becomes possible. The automated repair process presents new challenges, including providing materials such as abrasive articles for sanding or polishing, fluids such as water for wet sanding or polish, and removing used materials and waste from the vehicle surface. Described herein are some solutions for providing polish to a repair area. While paint spraying is done in large volumes, and requires longer pressurized lines running from a source to a dispenser, polish used in defect repair is used at much lower volumes. For automation of lower volume fluids, the presence of long fluid lines and dedicated machinery provides greater chance for clogs to develop as fluid sits and dries in the line. Additionally, some polishes can curdle if contact occurs with some metals. Polishing is currently a manual operation, with operators using a higher viscosity polish, dispensed from a squeeze bottle, to dispense polish on a defect repair spot. A solution is desired for dispensing use in automated robot repair units.

As used herein, the term “vehicle” is intended to cover a broad range of mobile structures that receive at least one coat of paint or clear coat during manufacturing. While many examples herein concern automobiles, it is expressly contemplated that methods and systems described herein are also applicable to trucks, trains, boats (with or without motors), airplanes, helicopters, etc.

As used herein, the term “robotic repair unit” refers to a robotic repair system that interacts with a surface to remove a defect. The robotic repair unit may be a stationary unit, that operates on a stationary surface, in some embodiments. In other embodiments, the robotic repair unit is a mobile repair unit that can move along a rail, track, or other mechanism such that it can address a defect on a moving surface. The robotic repair unit may have one or more end effectors with one or more tools, such as those described in U.S. Provisional Pat. Application with Serial No. 62/940950, filed Nov. 2, 2019 and Ser. No. 62/940960, also filed Nov. 2, 2019. However, other robotic repair unit constructions are also expressly contemplated.

Paint repair is one of the last remaining steps in the vehicle manufacturing process that is still predominantly manual. Historically, this is due to two main factors: lack of sufficient automated inspection and the difficulty of automating the repair process itself.

Progress has been made on the inspection portion, and with respect to the problem of abrading a surface to address a defect in a visually acceptable manner, as described in U.S. Provisional Pat. Application 62/941286, filed Nov. 27, 2019. However, as automation progresses, additional problems have arisen, including how to provide abrasive materials, including abrasive articles, and fluids required for the abrading process, as well as how to remove or exchange used abrasive materials from the surface.

Additionally, while higher viscosity polishes are currently used for manual repair processes, the viscosity brings additional challenges for robotic repair processes as higher viscosity fluids require greater pressure drops to deliver and can result in more clogs in the delivery line. Additionally, while higher viscosity makes manual processes easier, it is not a necessary property for successful polish. It is desired that a polish be dispensable by a pneumatic dispenser and remain in place without significant dripping during the repair process.

In some embodiments described herein, it is further desired to provide a polish with viscosity that can be implemented in a self-contained solution for a robotic arm. The self-contained solution, in some embodiments, would benefit from a lower viscosity polish as pumps or other pressure inducing mechanisms would not be needed to assist in dispensing the polish. Fewer components allows for easier replacement of the self-contained system. Lower viscosity polish can simplify the delivery system and providing better consistency of spray pattern.

Traditional abrasive polish for vehicle surface repair products are made at high viscosity for easy manual application. Robotic polishing can use a nozzle that atomizes the material which does not have the usual “running” problem of polish on vertical surfaces. Low viscosity polish provides an improvement with this system that results in better quality spray pattern, less supply pressure, and smaller components that more easily fit on end of arm robotic assemblies.

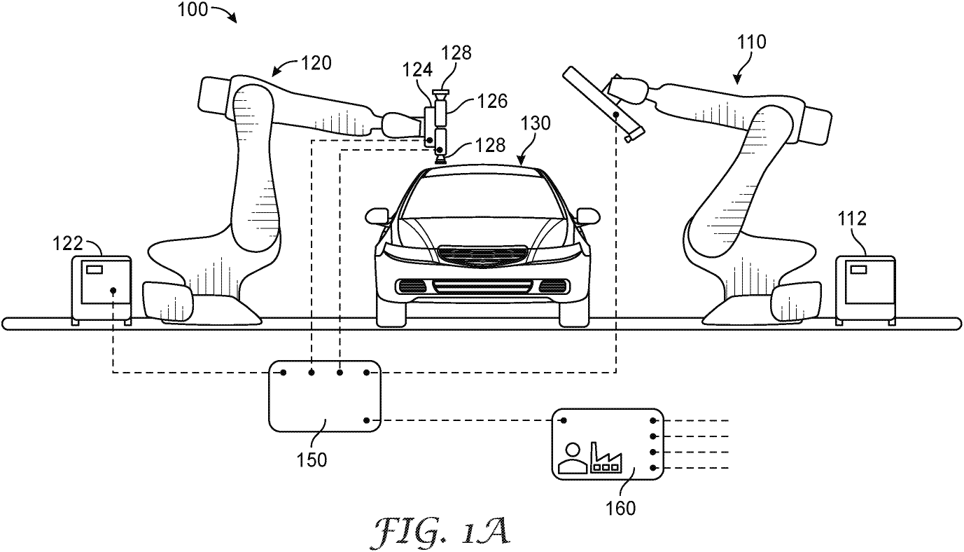

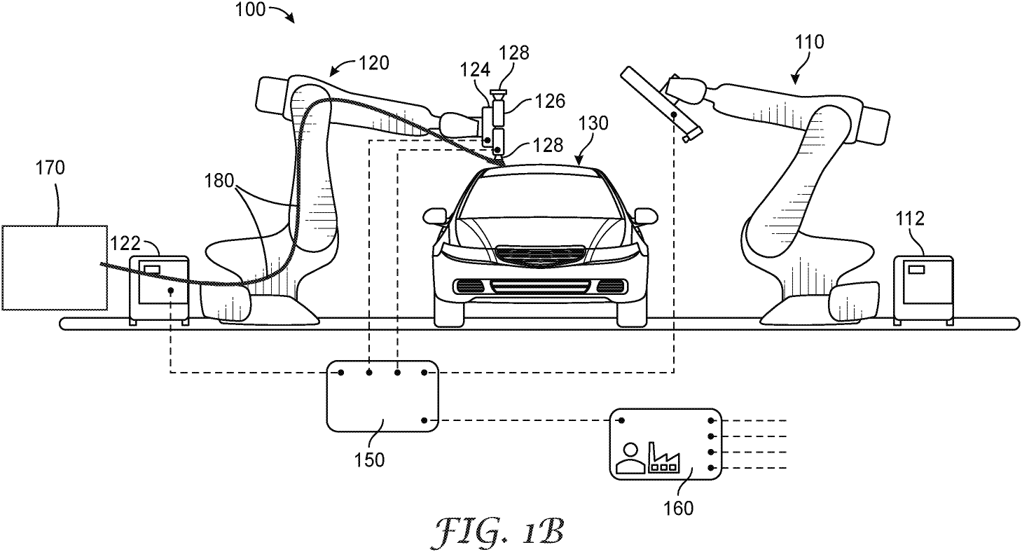

FIG. 1A is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIGS. 1, end effector 126 includes two tools 128, which may be arranged, in one embodiment, as further described in U.S. Provisional Pat. Application with Serial No. 62/940950 and Ser. No. 62/940960, both filed Nov. 2, 2019. However, other arrangements are also expressly contemplated. Visual inspection unit 110 may detect defects on a vehicle surface 130, which may be repaired by repair unit 120.

The presence of a sufficiently capable inspection system 110 is important for identifying and addressing defects for repair by repair unit 120. The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force)). Closed-loop force control approaches have been used (with limited utility) to address the latter along with more recent (and more successful) force controlled flanges that provide a soft (i.e., not stiff) displacement curve much more amenable to sensitive force/pressure-driven processing.

Some repair processes use fluids to accelerate or otherwise aid the abrasive removal process. For example, some sanding operations are wet sanding operations, requiring water, or another fluid, to be dispersed on the repair area prior to, or during, an abrading operation. Wet sanding may extend the life of an abrasive article and limits dust and contaminants as well as keeping abrasive temperatures low. Additionally, polishing often requires polish to be dispensed before, or during, the polishing operation. Water, or another removal solvent, may be dispensed to remove debris after the repair is completed.

For manual polishing operations, a buffing pad made from foam or wool is usually pre-treated with a small amount of polish in addition to the polish applied to a defect area. Currently a pea sized drop is applied per defect. Polishes for manual polishing operations are intentionally formulated with a high viscosity to reduce the risk of the polish dripping or running on a vehicle surface.

Currently, fluids needed for automated paint and repair systems, as shown in FIG. 1B, include a fluid source 170 coupled to a fluid line 180, that extends from fluid source 170 to a dispenser (e.g. tool 128 or placed near tool 128). However, the longer that fluid line 180 needs to be, the greater pressure differential that is needed to transport fluid from source 170 to a dispensing location. This may require a dedicated pump located near source 170, or near the dispensing point, or both. Further, as the viscosity of the fluid increases, the pressure needed both to dispense fluids and to clean dedicated fluid lines further increases.

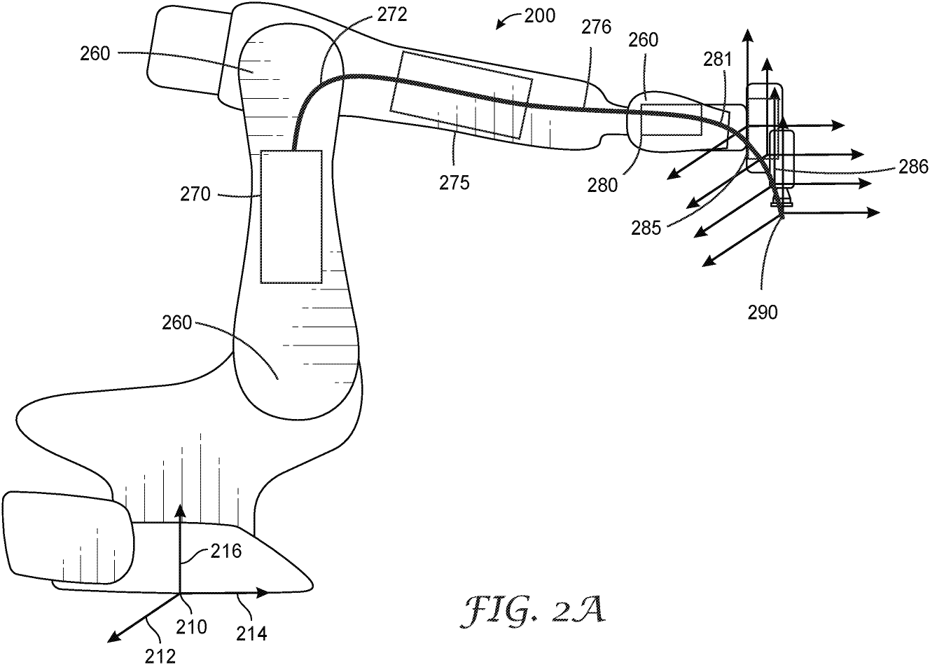

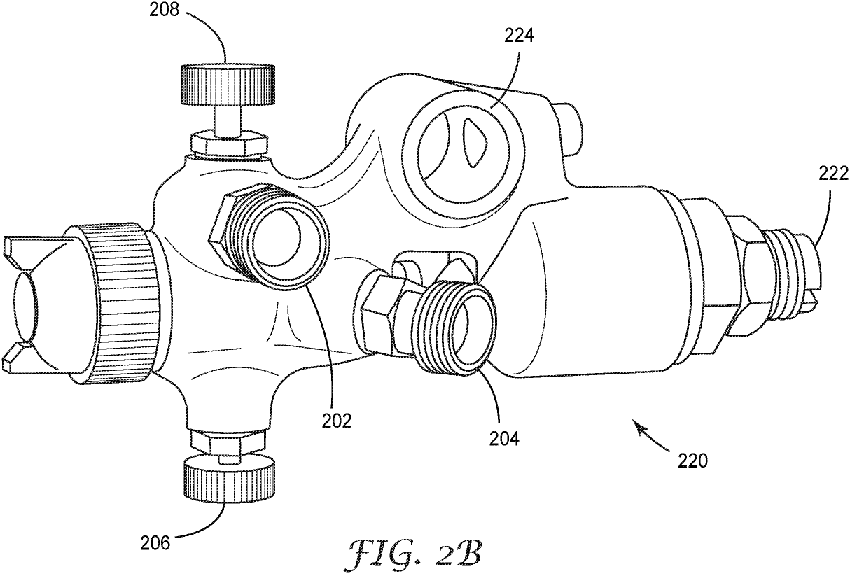

Additionally, because robot repair unit 120 has several degrees of freedom, discussed below with respect to FIG. 2A, line 180 also needs to be flexible to accommodate the different configurations needed for tools 128 to interact with defects at different points of surface 130. The fluid may need to be dispensed at a first defect 192, and then a second defect 194. As defects 192, 194 are different distances, and heights, from fluid source 170, this may require dynamic pressure control provided by a pump at source 170, and / or at the dispenser. A solution is desired that reduces the need for dedicated machinery and offers a lower cost option for providing fluids to a repair area on a work surface.

Additionally, different fluids are needed for different parts of the repair process. For example, wet sanding requires a water source 170. A polishing operation may use a first polish, from a first polish source 170, for a first polishing operation, followed by a second polish, requiring a second polish source 170, for a second polishing operation. This requires several fluid sources 170, each with a fluid line 180, to avoid contaminating or mixing dispensed fluids. Since many of these fluids are used at relatively low volumes for a given repair operation, this results in fluids sitting in fluid lines 180 when not in use, which can result in drying, separation, or clogging occurring. In addition to potentially providing subpar dispensed fluids, this can also result in damage to line 180 and any associated pump, dispenser, or nozzle located downstream of source 170. Currently, this risk is mitigated by running solvents through line 180, a dispenser and nozzle, and any pumping mechanisms, to ensure the fluid pathway is clear before connection to a new fluid source 170. However, this requires the use of solvents which are often not environmentally friendly, and it results in waste of polish or other fluids that are flushed out of line 180. A solution is desired that reduces the need for dedicated fluid delivery machinery and reduces the likelihood of damage to robotic repair unit 120 or associated components, while providing a consistent source of fluids needed for abrading operations.

FIG. 2A is a schematic of a paint repair robot which may be useful in embodiments of the present invention. A robotic repair unit 200 has a base 210, which may be stationary, in some embodiments. In other embodiments, base 210 can move in any of six dimensions, translations or rotations about an x-axis, y-axis and/or z-axis. For example, robot 200 may have a base 210 fixed to a rail system configured to travel along with a vehicle being repaired. Depending on a defect location, robot 200 may need to move closer, or further away from a vehicle, or may need to move higher or lower with respect to the vehicle. A moveable base 200 may make repairing difficult to reach defects easier.

Robotic repair unit 200 has one or more tools 240 that can interact with a worksurface. Tool 240 may include a backup pad, in one embodiment, or another suitable abrasive tool. During an abrasive operation, tool 240 may have an abrasive disc, or other suitable abrasive article, attached using adhesive, hook and loop, clip system, vacuum or other suitable attachment system. As mounted to the robotic repair unit 200, tool 240 has the ability to be positioned within the provided degrees of freedom by the robotic repair unit 200 (6 degrees of freedom in most cases) and any other degrees of freedom (e.g., a compliant force control 230 unit) with its reference frame.

Robotic repair unit 260 has several joints 260, each of which can move in x and y directions, as illustrated in FIG. 2A. Additionally, in some embodiments where joints 260 are ball joints, they may each also allow for movement in a z direction. The ability of robotic repair unit to move is important, as it allows access to defects at different positions on a vehicle to be repaired. However, it does present difficulties when designing for fluid provision from an external source.

A solution is desired that reduces the distance that polish needs to travel from a polish source to a dispensing location. Additionally, a solution is desired that results in the reduced use of harmful or environmentally unfriendly solvents. Additionally, a solution is desired that results in improved control over polish dispensing. Embodiments provided herein provide self-contained polish dispensing systems that can be mounted to a robotic repair unit and easily replaced without the need for harmful solvents.

FIG. 2A also illustrates several potential placement positions for mounting a self-contained fluid dispensing system. A dispenser may be positioned near dispensing point 290. The dispenser may include a pneumatic gun that, using an air source (not shown) atomizes an incoming fluid stream and dispenses the fluid stream through a nozzle. Many components of the self-contained system may be disposable, or easily replaceable. For example, any of the polish line, polish container, as well as a nozzle may be easily replaceable. In some embodiments, replaceable components are made from a plastic that is inert with respect to the polish being dispensed.

As illustrated in FIG. 2A, a robotic repair unit 200 can have a self-contained polish dispensing system located in any suitable location. For example, a polish container 285 may be located on or downstream from a force controller, such that polish only travels through line 286 prior to reaching a dispensing location 290. This position may allow for automatic detection of a low fluid amount, for example by sensing that a current weight of container 285 is nearing or has reached empty. Additionally, in some embodiments, the low viscosity polish can be supplied from far away from the robot as well. In some cases this can be an advantage.

In another embodiment, polish container 280 is located on a third arm portion, such that fluid travels through line portion 281, as well as line portion 286, prior to reaching dispensing location 290. While line 281 may need to experience some flexibility, positioning polish container in position 280 keeps a vertical travel distance for the polish to travel relatively constant.

In another embodiment, polish container may be placed in position 275, on a second arm portion. The presence of a joint between second and third arm portions may require line portion 276 to have some flexibility or require some built in slack to accommodate movement of robot unit 200 during repair of defects on a vehicle surface.

In another embodiment, a polish container 270 can be located on a first arm portion, such that polish flows through a fluid line 272 to dispensing location 290. This position may require additional pressure control to ensure that polish can be dispensed on repair defect locations that place a dispensing location 290 lower than a fluid exit point from fluid container 270.

As illustrated in FIG. 2A, as polish container is positioned further away from dispensing location 290, the length of a needed fluid line increases, as does the amount of pressure needed to transport fluid to dispensing location 290. Having a polish with a lower viscosity reduces the need for dedicated equipment, and may even allow for either a cheaper, single-use pump to be used in some embodiments, or no pump, in others where gravity alone is sufficient to force polish to flow to and through a dispenser.

FIG. 2A illustrates polish containers 270, 275, 280 and 285 as mounted directly to a component of robotic repair unit 200. However, this is for the purposes of understanding only. A polish container may also be mounted above a component, for example extending from first, second, or third arm portions to take advantage of gravitational forces to assist in dispensing fluids.

Some examples of self-contained fluid systems are illustrated and described in co-pending U.S. Provisional Application with Serial No. 62/981,058.

FIG. 2B illustrates a pneumatic dispenser for an automated repair unit. However, while a pneumatic dispenser is illustrated, the supply pressure of the polish can be supplied by a pump or cylinder that supplies the backpressure instead of pneumatics. Pneumatic dispenser 220 includes an air inlet 202 and a fluid inlet 204. A fluid dispensing control 206 may allow for adjusting of a fan spray width, for example by increasing or reducing experienced fluid pressure. Pneumatic dispenser 220 may also include an air flow control 208, which may allow for reducing or increasing air pressure. Dispenser 220 may include a mounting mechanism 224, which may allow for mounting to a tool, or an end effector, of a robotic repair unit. System may also have a fluid needle adjustment 222, in some embodiments.

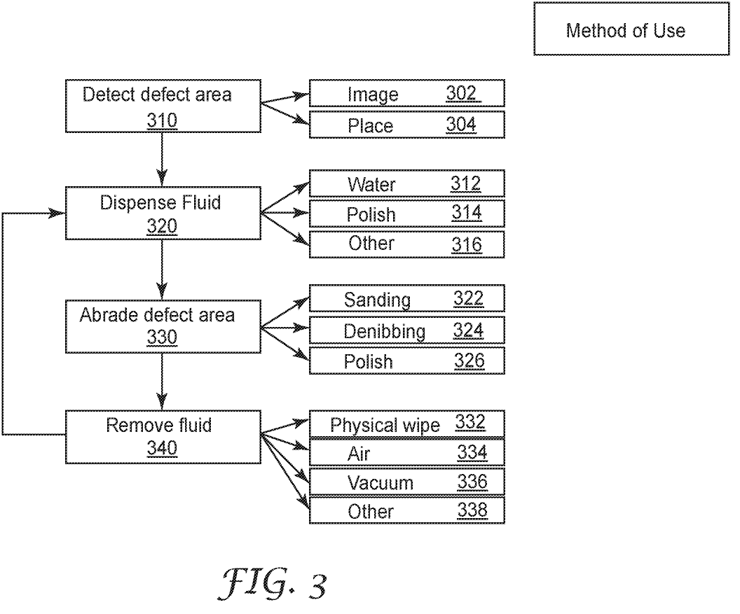

FIG. 3 illustrates a method of robotic defect repair in accordance with an embodiment of the present invention. The method of FIG. 3 is an overview of how a robotic repair system repairs a defect in accordance with at least some embodiments described herein.

In block 310, a defect area is detected and instructions related to the detected defect are received by a repair unit from a robot controller, such as application controller 150 in FIG. 1A, for example. Without limitation to the embodiments discussed herein, the defect area can be detected by an image 302 of the surface or can be associated with a position on the vehicle 304.

Blocks 320, 330, and 340 concern the steps of repairing a detected defect. Defects may be repaired in one or more abrasive operations. For example, a defect area may first be sanded, then polished. A defect may be inspected in between the sanding and polish step and, depending on whether the defect was successfully repaired, the steps of sanding and / or polishing may be repeated.

In block 320, polish is dispensed onto a repair area. The fluid may be, for example, water 312 for a wet sanding or wet polishing operation. The fluid may also be, for a polishing operation, a low viscosity polish 314. Polish 314 may actually refer to a variety of polishes useful for different operations.

Different polishes 314 may have different viscosities. As described herein, a low viscosity polish, is defined as a polish with a viscosity of less than 40,000 cp. In some embodiments, a low viscosity polish is a polish with a viscosity below 30,000 cp. In some embodiments, a low viscosity polish is a polish with a viscosity below about 20,000 cp. In some embodiments, a low viscosity polish is a polish with a viscosity below about 10,000 cp. In some embodiments, a low viscosity polish is a polish with a viscosity below about 5,000 cp. In some embodiments, a low viscosity polish is a polish with a viscosity below about 4,000 cp. In some embodiments, a low viscosity polish is a polish with a viscosity below about 3,000 cp. In some embodiments, a low viscosity polish is a polish with a viscosity below about 2,000 cp. In some embodiments, a low viscosity polish is a polish with a viscosity below about 1,800 cp. In some embodiments, a low viscosity polish is a polish with a viscosity below about 1,500 cp. In some embodiments, a low viscosity polish is a polish with a viscosity below about 1,200 cp. In some embodiments, a low viscosity polish is a polish with a viscosity below about 1,100 cp. In some embodiments, a low viscosity polish is a polish with a viscosity below about 1,000 cp. In some embodiments, a low viscosity polish is a polish with a viscosity below about 900 cp. In some embodiments, a low viscosity polish is a polish with a viscosity below about 800 cp. In some embodiments, a low viscosity polish is a polish with a viscosity below about 700 cp. In some embodiments, a low viscosity polish is a polish with a viscosity below about 600 cp. In some embodiments, a low viscosity polish is a polish with a viscosity below about 500 cp. In some embodiments, a low viscosity polish is a polish with a viscosity below about 400 cp. In some embodiments, a low viscosity polish is a polish with a viscosity below about 300 cp. In some embodiments, a low viscosity polish is a polish with a viscosity below about 200 cp. In some embodiments, a low viscosity polish is a polish with a viscosity below about 100 cp.

In some embodiments, the low viscosity polish is a water-based polish. In some embodiments, the low viscosity polish includes petroleum distillates. In some embodiments the petroleum distillates are hydrotreated light petroleum distillates or Light Petroleum Distillates (Acid Treated), or Solvent Refined Hydrotreated Middle Distillate, or other Petroleum Distillates. In some embodiments, the low viscosity polish includes aluminum oxide mineral, which may be present in a non-fibrous form. In some embodiments, the low viscosity polish includes glycerin. In some embodiments, the low viscosity polish includes mineral oil, such as white mineral oil.

In some embodiments, the low viscosity polish is a wax-free polish. In some embodiments, the low viscosity polish is free of silicones. Waxes and silicones are often avoided for vehicle polishes due to fear of contamination to other surfaces that could cause problems with adhesion of the paint.

Other fluids 316 may also be dispensed, depending on the repair operation. The fluid may be dispensed using a self-contained fluid dispensing system, such as those described in embodiments herein or any other suitable self-contained fluid dispensing system.

In block 330, the defect is abraded. Abrading a defect may include a sanding operation 322, a denibbing operation 324, a polishing operation 326, or another operation 328. Abrading the defect includes bringing a tool into contact with the defect area. Abrading may occur after, or simultaneously with the fluid dispensing of block 320.

In block 340, the fluid is removed from the work surface. Removing the fluid may also include removing waste produced from the abrasive operation, including clear coat or paint swarf. Removing fluid may be done manually, during a human inspection operation, or may be done automatically by a tool on the repair unit or by another robotic unit altogether. Fluid removal may include a physical wiping operation 332, with an absorbent article, using a blowing operation 334, a vacuum operation 836, or another suitable operation 338.

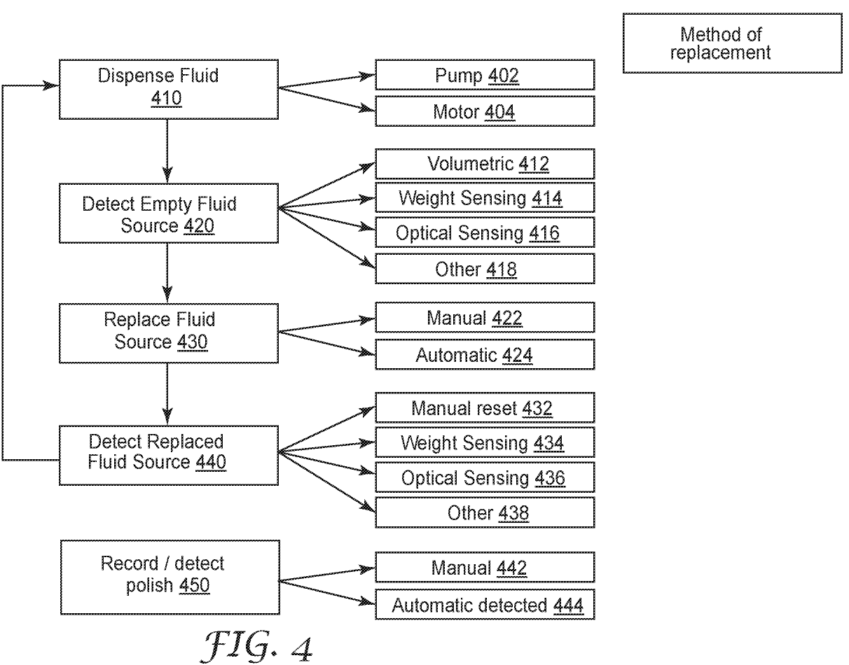

FIG. 4 illustrates a method of replacing a self-contained polish dispensing system. The system may include, for example, components similar to those described in co-owned U.S. Provisional Application with Serial No. 62/981,058, incorporated herein by reference, or another suitable self-contained system. A self-contained polish dispensing system, as contemplated by embodiments herein, involves some single use components that are mounted to a robotic repair arm. The self-contained system is mounted wholly on the robotic repair unit. Some single-use components include, for example, a liner or container that directly contacts the low viscosity polish. Additionally, a fluid line or connection between a polish container and a dispenser may be a single-use component. Any pump associated with the fluid line may be a single-use component. The nozzle mounted to a dispenser may also be disposable. At least some polish compositions may curdle if it contacts carbon steel. For that reason, it is desired that the polish be contained such that it can be replaced without contacting metal components of the robotic repair unit. Single-use, disposable components help reduce solvent usage in the repair area.

In block 410, polish is dispensed by the polish dispensing system. The polish may be dispensed using a pump 402, which may have an associated motor 404. However, other fluid movement mechanisms are also contemplated, as indicated in block 406. For example, a pump may not be needed in embodiments where the polish viscosity is sufficiently low, and the polish container is placed such that gravitational forces provide sufficient pressure. Additionally, a polish container may be coupled to a compressed air source, which may provide compressed air at a pressure sufficient to cause the polish to flow to a dispenser.

In block 420, it is detected that the polish container is empty, or running low. The low fluid level can be detected using volumetric tracking 412, for example using a pump or motor system that can volumetrically track polish as it flows to a dispenser. The low fluid level can also be detected using weight sensing 414, for example in an embodiment where the polish container is mounted on the tool side of the force control. The force control is sensitive to weight, and can accurately measure either a change in weight corresponding to almost (or all) of the polish being dispensed from the polish container, or may detect that a current weight corresponds to a low fluid level. In another embodiment, the low fluid level can be detected with an optical sensor 416. For example, polish may not be optically clear. In one embodiment, an optical sensor may be able to detect a current fluid level and detect when a current fluid level drops to or below a replacement level. In another embodiment, an optical sensor may be able to detect that a bag-type fluid container has reduced in volume, or compressed enough that a low fluid level has been achieved.

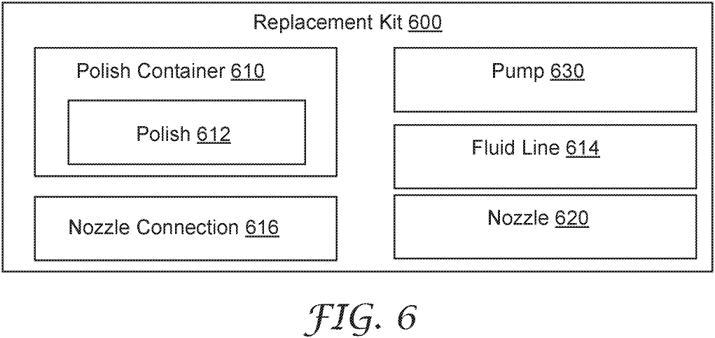

In block 430, a polish source is replaced. A self-contained fluid dispensing system may contain a dispenser, a fluid container, a fluid liner within the fluid container, a line connecting the container to the dispenser, and a nozzle. Replacing the polish source may include replacing some or all of these components. In order to avoid the use of potentially carcinogenic or otherwise harmful solvents, it may be preferred that the components interacting with polish being dispensed be replaced each time polish is changed or replaced. For example, a used polish liner and a used polish line may be replaced with a new polish liner, filled with new polish to be dispensed, and a new polish liner. In some embodiments, a nozzle may also be replaceable. In embodiments where the polish is dispensed directly from a container, the used container is replaced with a new container. The new components may come from a kit, in some embodiments and as illustrated in FIG. 6, such that the new fluid-filled liner or fluid-filled container is filled with a predetermined amount of a given fluid.

Polish replacement may require some manual intervention, as indicated in block 422. For example, when a low or empty polish level is detected, a robotic repair unit may indicate, either visually, audibly, or through another suitable alert, that replacement is needed. A human operator may then remove the used components and replace them with new components. In another embodiment, at least some portion of the replacement is automatic, as indicated in block 424. For example, the robotic repair unit, or another robotic unit, may retrieve the used components, dispose of the used components, retrieve the new components, and / or mount the new components.

In block 440, the replaced polish is detected. The robotic repair unit may detect that the polish has been replaced, in some embodiments. Replacement may be detected, for example, by an operator manually resetting a fluid flow counter, as indicated in block 432. For example, in the embodiment where the self-contained polish dispensing system includes a servo motor that can measure a volume of fluid dispensed, manual reset may include resetting a count to zero. Detecting a new polish unit may also include a weight sensor detecting that a tool-side weight corresponds to a full polish container, as indicated in block 434, for embodiments where the polish container is mounted on a portion of the robotic repair unit where weight sensing is feasible. Detecting the replaced polish unit may also include optical sensing, for example an optical sensor detecting that a new polish container has been reinstalled. Other suitable sensing systems may also be feasible for other embodiments.

In block 450, the type of polish installed on the robotic repair unit is recorded. For example, in embodiments where the new components are part of a kit, the new polish container or liner may include a barcode / QR code or other signifier of the contents. Depending on the given polish installed, a controller may alter a repair trajectory or force profile of an abrasive tool. In embodiments where the new components include a signifier, the fluid parameters may be automatically detected, as indicated in block 444, and communicated to a controller. However, it is also contemplated that manual recording, as indicated in block 442, may also be done.

Components of the self-contained polish dispensing system are designed to be disposable, in some embodiments, to reduce the need for unpleasant, harmful and environmentally caustic chemicals. In some embodiments, the only component not replaced is the dispenser itself. The replaceable components, including the liner, container, fluid line, and nozzle may all be made of a plastic material that is cheap enough to replace with each exchange of polish. In embodiments where the nozzle is part of the components being replaced, the replacement is essentially solvent-free. In embodiments where the dispenser is mounted to a robotic arm, the polish container may be designed to provide enough polish for at least one day’s worth of polishing, and up to one week’s worth of polishing. This may be accomplished with a volume of about 1 liter, about 2 liters, about 3 liters, about 4 liters, or even about 5 liters. However, in other embodiments the polish is provided from another position, either mounted elsewhere to a robotic repair unit, or stored in a separate polish storage container.

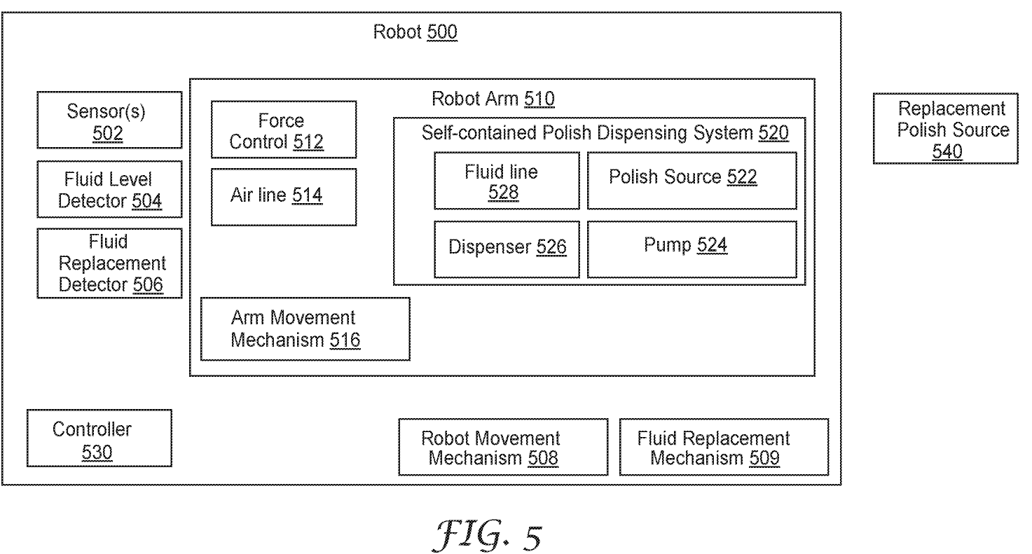

FIG. 5 illustrates a robotic repair unit 500 in accordance with embodiments discussed herein. Robot 500 may have a robotic movement mechanism 508 that may allow for robot 500 to move, for example with respect to a vehicle being repaired. Robot 500 also includes a controller 530 that may control movement of robot 500 and its components, either based on manual input or based on input received from sensors 502. Robot 500 may also include sensors specific to a self-contained polish dispensing system 520, such as a fluid level detector 504 and a fluid replacement detector 506. However, these sensors may be mounted separately from the robot 500, on the robot arm 510, or as part of the self-contained polish dispensing assembly 520.

Robotic repair unit 500 includes a robot arm 510. Robot arm 510 includes one or more tools on an end effector (not shown) that are mounted to a force control 512. Robot arm 510 may also have an air line 514 mounted, in embodiments where compressed air is needed to force polish through fluid line 528 to dispenser 526. Robot arm 510 may have its own movement mechanism 516 which facilitates placement of arm components, and of tools (not shown) with respect to a surface being repaired.

Self-contained polish dispensing system 520 is mounted on robot arm 510. As described above, self-contained polish dispensing system may be mounted to any suitable arm component of a robot arm 510. However, it may be beneficial for fluid source 522 to be mounted on a tool side of force control 512 to take advantage of weight sensing. Other placements are also expressly contemplated, however. Self-contained polish dispensing system includes components intended to be disposed after a single use, to reduce the use of harmful solvents in the repair area. A fluid line 528 transports polish from polish source 522 to dispenser 526. Depending on a viscosity of the polish being dispensed, as well as the relative placement of polish container 522 with respect to dispenser 526, a pump 524 may be necessary to facilitate fluid flow. In some embodiments, an air line 514 is provided to fluid source 522 to provide an additional source of pressure on fluid being dispensed to facilitate an even flow.

When polish container 522 is empty, or has reached a low enough level that replacement is indicated, replacement components are retrieved from replacement polish source 540. Replacement of fluid line 528, polish container 522, and / or pump 524 may occur manually, semi-automatically, or automatically.

FIG. 6 illustrates a replacement kit for a self-contained polish dispensing system. Replacement kit 600 includes a polish container 610 which contains low viscosity polish 612. Polish container 610 is a single use container intended to be replaced after polish 612 is used. Polish container 610 may include an opening 613 that can couple to a source of compressed air, which provides additional pressure to force polish 612 to dispense. However, opening 613 may not be needed in embodiments where polish 612 has a low enough viscosity to flow on its own, or where a pump 630 is present to assist in facilitating fluid flow.

As described herein, a low viscosity polish, is defined as a polish with a viscosity of less than 40,000 cp. In some embodiments, a low viscosity polish is a polish with a viscosity below 30,000 cp. In some embodiments, a low viscosity polish is a polish with a viscosity below about 20,000 cp. In some embodiments, a low viscosity polish is a polish with a viscosity below about 10,000 cp. In some embodiments, a low viscosity polish is a polish with a viscosity below about 5,000 cp. In some embodiments, a low viscosity polish is a polish with a viscosity below about 4,000 cp. In some embodiments, a low viscosity polish is a polish with a viscosity below about 3,000 cp. In some embodiments, a low viscosity polish is a polish with a viscosity below about 2,000 cp. In some embodiments, a low viscosity polish is a polish with a viscosity below about 1,800 cp. In some embodiments, a low viscosity polish is a polish with a viscosity below about 1,500 cp. In some embodiments, a low viscosity polish is a polish with a viscosity below about 1,200 cp. In some embodiments, a low viscosity polish is a polish with a viscosity below about 1,000 cp. In some embodiments, a low viscosity polish is a polish with a viscosity below about 800 cp. In some embodiments, a low viscosity polish is a polish with a viscosity below about 700 cp. In some embodiments, a low viscosity polish is a polish with a viscosity below about 600 cp. In some embodiments, a low viscosity polish is a polish with a viscosity below about 500 cp. In some embodiments, a low viscosity polish is a polish with a viscosity below about 400 cp. In some embodiments, a low viscosity polish is a polish with a viscosity below about 300 cp. In some embodiments, a low viscosity polish is a polish with a viscosity below about 200 cp. In some embodiments, a low viscosity polish is a polish with a viscosity below about 100 cp.

In some embodiments, the low viscosity polish is a water-based polish. In some embodiments, the low viscosity polish includes petroleum distillates. In some embodiments the petroleum distillates are hydrotreated light petroleum distillates. In some embodiments, the low viscosity polish includes aluminum oxide mineral, which may be present in a non-fibrous form. In some embodiments, the low viscosity polish includes glycerin. In some embodiments, the low viscosity polish includes mineral oil, such as white mineral oil. In some embodiments, the low viscosity polish is a wax-free polish. In some embodiments, the low viscosity polish is free of silicones.

Because low viscosity polishes described herein are intended to be stored in single use containers and easily installed and removed on a robotic arm, it is important that the polish can be manufactured and stored prior to use. The low viscosity polish needs to include ingredients that are inert with respect to each other and that are stable. The low viscosity polish, in some embodiments, is also installable without further treatment such as heating or cooling. The polish should also include ingredients that stay in solution and do not experience substantial separation during storage.

Replacement kit 600 may also include a connection 616 to couple a polish container 610 directly to a dispenser, or directly to a fluid line 614. In some embodiments, replacement kit 600 also includes a nozzle 620. Connection 616 may couple polish container 610 directly to nozzle 620, such that a fluid line 614 is not required.

In some embodiments, polish container 610 may be a liner that is coupled to fluid line 614 through a separate container that does not require replacement each time that fluid needs replenishing.

A polish dispensing system for a robotic repair unit is presented that includes a polish container filled with a low viscosity polish, a polish dispenser associated with a robotic repair unit, a coupler that connects the polish container to the fluid dispenser;, and a mounting mechanism configured to couple the polish container to a robotic repair unit.

The polish dispensing system may be implemented such that the polish dispensing system is self-contained on the robotic repair unit.

The polish dispensing unit may be implemented such that the robotic repair unit is a first robotic repair unit. The polish dispenser is a first polish dispenser, and the polish container also provides polish to a second robotic repair unit with a second dispenser.

The polish dispensing system may be implemented such that it also includes a pump.

The polish dispensing system may be implemented such that it also includes a motor.

The polish dispensing system may be implemented such that it also includes an air source coupled to the polish container.

The fluid dispensing system may be implemented such that the polish dispenser is a pneumatic polish dispenser.

The polish dispensing system may be implemented such that the polish container and the coupler are disposable.

The polish dispensing system may be implemented such that the polish container and the coupler include plastic.

The polish dispensing system may be implemented such that the polish container is a liner. The liner may be disposable.

The polish dispensing system may be implemented such that the polish liner is a compressible liner that compresses in volume as the low viscosity polish is dispensed.

The polish dispensing system may be implemented such that the polish dispensing system is mounted such that gravity provides some of the pressure needed for polish to flow from the polish container to the dispenser.

The polish dispensing system may be implemented such that the polish dispensing system is mounted such that gravity provides all of the pressure needed for the low viscosity to flow from the polish container to the fluid dispenser.

The polish dispensing system may be implemented such that the polish container includes a port configured to receive a source of compressed air.

The polish dispensing system may be implemented such that the polish dispensing system includes a disposable nozzle that couples to the dispenser.

The polish dispensing system may be implemented such that the polish container and the coupler are single use components.

The polish dispensing system may be implemented such that the polish container and the coupler include plastic.

The polish dispensing system may be implemented such that the polish container includes a signifier that identifies a low viscosity polish in the polish container.

The polish dispensing system may be implemented such that the polish dispensing system is a solvent free system.

The polish dispensing system may be implemented such that the coupler includes a connector that directly connects the polish container to the dispenser.

The polish dispensing system may be implemented such that the coupler includes a fluid line.

The polish dispensing system may be implemented such that the fluid line is flexible.

The polish dispensing system may be implemented such that the polish container is configured to be mounted on a tool side of a force control.

The polish dispensing system may be implemented such that it includes a sensor for detecting a low fluid level. The sensor may include a weight sensor, an optical sensor, or a volumetric sensor.

The polish dispensing system may be implemented such that the low viscosity polish has a viscosity below 40,000 cp, or below 30,000 cp, or below 20,000 cp, or below 10,000 cp, or below 8,000 cp, or below 6,000 cp, or below 5,000 cp, or below 4,000 cp, or below 3,000 cp, or below 2,000 cp, or below 1,000 cp, or below 800 cp, or below 600 cp, or below 400 cp, or below 200 cp, or below 150 cp.

The polish dispensing system may be implemented such that the low viscosity polish is free of wax compounds.

The polish dispensing system may be implemented such that the low viscosity polish is free of silicones.

The polish dispensing system may be implemented such that the low viscosity polish includes a plurality of compounds that are inert with respect to each other.

The polish dispensing system may be implemented such that the low viscosity polish requires no additional processing to use.

The polish dispensing system may be implemented such that the low viscosity polish includes water.

The polish dispensing system may be implemented such that the low viscosity polish includes petroleum distillates.

The polish dispensing system may be implemented such that the low viscosity polish includes hydrotreated light petroleum distillates.

The polish dispensing system may be implemented such that the low viscosity polish includes aluminum oxide mineral.

The polish dispensing system may be implemented such that the low viscosity polish includes glycerin.

The polish dispensing system may be implemented such that the low viscosity polish includes mineral oil.

The polish dispensing system may be implemented such that the mineral oil is white mineral oil.

A method of providing a low viscosity polish for a repair operation is presented that includes positioning a polish dispenser in proximity to a repair area, and automatically dispensing the low viscosity polish to the repair area, from the dispenser. The dispenser receives the low viscosity polish from a self-contained polish dispensing system mounted to a robotic repair unit. The self-contained polish dispensing system includes a polish container, configured to hold the low viscosity polish prior to dispensing, coupled to the dispenser.

The method may be implemented such that the polish container includes a disposable liner that contains the polish.

The method may be implemented such that the polish container includes an air port that receives compressed air.

The method may be implemented such that it also includes metering the dispensed polish.

The method may be implemented such that the disposable liner is a bag-type liner that compresses as polish is dispensed.

The method may be implemented such that the disposable liner is plastic.

The method may be implemented such that the polish container is coupled to the dispenser using a coupler. The polish container is a single use container.

The method may be implemented such that the coupler is a single-use fluid line.

The method may be implemented such that the coupler is a single-use coupler.

The method may be implemented such that the dispenser couples to a nozzle.

The method may be implemented such that the nozzle is a single-use nozzle.

The method may be implemented such that the self-contained polish dispensing system is configured to be replaced without using solvents or cleaning agents.

The method may be implemented such that it also includes removing the dispensed polish from the repair area.

The method may be implemented such that the repair area includes a defect.

The method may be implemented such that the defect is on a vehicle.

The method may be implemented such that the vehicle and the robotic repair unit are moving during the step of automatically dispensing the polish to the repair area.

The method may be implemented such that automatically dispensing the fluid includes dispensing a metered amount of polish.

The method may be implemented such that the metered amount is controlled by a controller associated with the robotic repair unit.

The method may be implemented such that the low viscosity polish has a viscosity below 40,000 cp, or below 30,000 cp, or below 20,000 cp, or below 10,000 cp, or below 8,000 cp, or below 6,000 cp, or below 5,000 cp, or below 4,000 cp, or below 3,000 cp, or below 2,000 cp, or below 1,000 cp, or below 800 cp, or below 600 cp, or below 400 cp, or below 200 cp, or below 150 cp.

The method may be implemented such that the low viscosity polish is free of wax compounds.

The method may be implemented such that the low viscosity polish is free of silicones.

The method may be implemented such that the low viscosity polish includes a plurality of compounds that are inert with respect to each other.

The may be implemented such that the low viscosity polish requires no additional processing to use.

The method may be implemented such that the low viscosity polish includes water.

The method of may be implemented such that the low viscosity polish includes petroleum distillates.

The method may be implemented such that the low viscosity polish includes hydrotreated light petroleum distillates.

The method may be implemented such that the low viscosity polish includes aluminum oxide mineral.

The method may be implemented such that the low viscosity polish includes glycerin.

The method may be implemented such that the low viscosity polish includes mineral oil.

The method may be implemented such that the mineral oil is white mineral oil.

A method of replacing a polish source on a robotic repair system is presented that includes detecting, using a first sensor, a polish level has reached a replacement fluid level in a used polish source, removing the used polish source, installing a new polish source and detecting, using a second sensor, the new polish source is installed.

The method may be implemented such that installing the new polish source includes installing a new polish source in a container mounted to the robotic repair system.

The method may be implemented such that installing the new polish source includes connecting the new polish source to a dispenser mounted to the robotic repair system.

The method may be implemented such that the new polish source is connected to the dispenser through a fluid line.

The method may be implemented such that the fluid line is a flexible fluid line.

The method may be implemented such that the flexible fluid line and the new polish source include single use material.

The method may be implemented such that the dispenser is mounted to the robotic repair system.

The method may be implemented such that the new polish source is mounted on a tool side of the robotic repair system.

The method may be implemented such that the first sensor is a weight sensor that detects a weight of the used polish source indicative of the replacement polish level.

The method may be implemented such that the replacement polish level is empty.

The method may be implemented such that the replacement polish level is a low fluid level.

The method may be implemented such that first sensor or the second sensor are each selected from: a weight sensor, a volumetric sensor, or an optical sensor.

The method may be implemented such that it also includes detecting a polish type associated with the new polish source and providing the detected polish type to a controller associated with the robotic repair unit.

The method may be implemented such that removing the used polish source includes removing disposable components of a self-contained polish dispensing system.

The method may be implemented such that the self-contained polish dispensing system includes a fluid line coupling a used polish container to the dispenser.

The method may be implemented such that the self-contained polish dispensing system includes a pump that facilitates dispensing polish through the fluid line.

The method may be implemented such that the used polish container is a used polish liner.

The method may be implemented such that the low viscosity polish has a viscosity below 40,000 cp, or below 30,000 cp, or below 20,000 cp, or below 10,000 cp, or below 8,000 cp, or below 6,000 cp, or below 5,000 cp, or below 4,000 cp, or below 3,000 cp, or below 2,000 cp, or below 1,000 cp, or below 800 cp, or below 600 cp, or below 400 cp, or below 200 cp, or below 150 cp.

The method may be implemented such that the low viscosity polish is free of wax compounds.

The method may be implemented such that the low viscosity polish is free of silicones.

The method may be implemented such that the low viscosity polish includes a plurality of compounds that are inert with respect to each other.

The method may be implemented such that the low viscosity polish requires no additional processing to use.

The method may be implemented such that the low viscosity polish includes water.

The method may be implemented such that the low viscosity polish includes petroleum distillates.

The method may be implemented such that the low viscosity polish includes hydrotreated light petroleum distillates.

The method may be implemented such that the low viscosity polish includes aluminum oxide mineral.

The method may be implemented such that the low viscosity polish includes glycerin.

The method may be implemented such that the low viscosity polish includes mineral oil.

The method may be implemented such that the mineral oil is white mineral oil.

A robotic repair unit is presented that includes a robotic arm with a force control coupled to an end effector containing an abrasive tool and a self-contained fluid dispensing system configured to dispense a low viscosity polish on a worksurface. The self-contained polish dispensing system includes a dispenser and a polish container coupled to the dispenser. The polish container is mounted to the robotic repair unit.

The method may be implemented such that replacement of the polish container is solvent free.

The method may be implemented such that the dispenser is a pneumatic dispenser.

The method may be implemented such that the polish container includes a liner directly contains the low viscosity polish.

The method may be implemented such that the polish container includes an air port configured to couple to a source of compressed air.

The method may be implemented such that it also includes a fluid line coupling the liner to the dispenser.

The method may be implemented such that the liner and the fluid line are single use articles.

The method may be implemented such that it also includes a single use pump.

The method may be implemented such that replacement of the single use liner and single use fluid line is solvent free.

The method may be implemented such that the dispenser includes a disposable nozzle.

The method may be implemented such that the polish container is mounted on a tool side of a force control unit of the robotic arm.

The method may be implemented such that the force control detects a change in weight of the polish container corresponding to a low fluid level.

The method may be implemented such that it also includes a detector configured to identify a polish type in a polish container.

The method may be implemented such that in the detector is configured to identify the fluid type based on a signifier on the fluid container.

The method may be implemented such that the low viscosity polish has a viscosity below 40,000 cp, or below 30,000 cp, or below 20,000 cp, or below 10,000 cp, or below 8,000 cp, or below 6,000 cp, or below 5,000 cp, or below 4,000 cp, or below 3,000 cp, or below 2,000 cp, or below 1,000 cp, or below 800 cp, or below 600 cp, or below 400 cp, or below 200 cp, or below 150 cp.

The method may be implemented such that the low viscosity polish is free of wax compounds.

The method may be implemented such that the low viscosity polish is free of silicones.

The method may be implemented such that the low viscosity polish includes a plurality of compounds that are inert with respect to each other.

The method may be implemented such that the low viscosity polish requires no additional processing to use.

The method may be implemented such that the low viscosity polish includes water.

The method may be implemented such that the low viscosity polish includes petroleum distillates.

The method may be implemented such that the low viscosity polish includes hydrotreated light petroleum distillates.

The method may be implemented such that the low viscosity polish includes aluminum oxide mineral.

The method may be implemented such that the low viscosity polish includes glycerin.

The method may be implemented such that the low viscosity polish includes mineral oil.

The method may be implemented such that the mineral oil is white mineral oil.

A low viscosity polish kit for a robotic repair unit is presented that includes a sealed container containing a low viscosity polish, the sealed container comprising a coupling mechanism and a connector configured to couple to the coupling mechanism, on a first end, and to a dispenser of a robotic repair unit, on a second end. The sealed container and the connector are single-use articles.

The kit may be implemented such that it also includes a nozzle configured to connect to the dispenser.

The kit may be implemented such that the nozzle is a single-use nozzle.

The kit may be implemented such that the sealed container and the connector include plastic.

The kit may be implemented such that the connector includes a fluid line.

The kit may be implemented such that it further includes a single-use pump.

The kit may be implemented such that the low viscosity polish has a viscosity below 40,000 cp, or below 30,000 cp, or below 20,000 cp, or below 10,000 cp, or below 8,000 cp, or below 6,000 cp, or below 5,000 cp, or below 4,000 cp, or below 3,000 cp, or below 2,000 cp, or below 1,000 cp, or below 800 cp, or below 600 cp, or below 400 cp, or below 200 cp, or below 150 cp.

The kit may be implemented such that the low viscosity polish is free of wax compounds.

The kit may be implemented such that the low viscosity polish is free of silicones.

The kit may be implemented such that the low viscosity polish includes a plurality of compounds that are inert with respect to each other.

The kit may be implemented such that the low viscosity polish requires no additional processing to use.

The kit may be implemented such that the low viscosity polish includes water.

The kit may be implemented such that the low viscosity polish includes petroleum distillates.

The kit may be implemented such that the low viscosity polish includes hydrotreated light petroleum distillates.

The kit may be implemented such that the low viscosity polish includes aluminum oxide mineral.

The kit may be implemented such that the low viscosity polish includes glycerin.

The kit may be implemented such that the low viscosity polish includes mineral oil.

The kit may be implemented such that the mineral oil is white mineral oil.

The kit may be implemented such that the polish container also includes a mounting mechanism for coupling to the robotic repair unit.

The kit may be implemented such that the polish container is a compressible container configured to fit in a container mounted to the robotic repair unit.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

### EXAMPLES

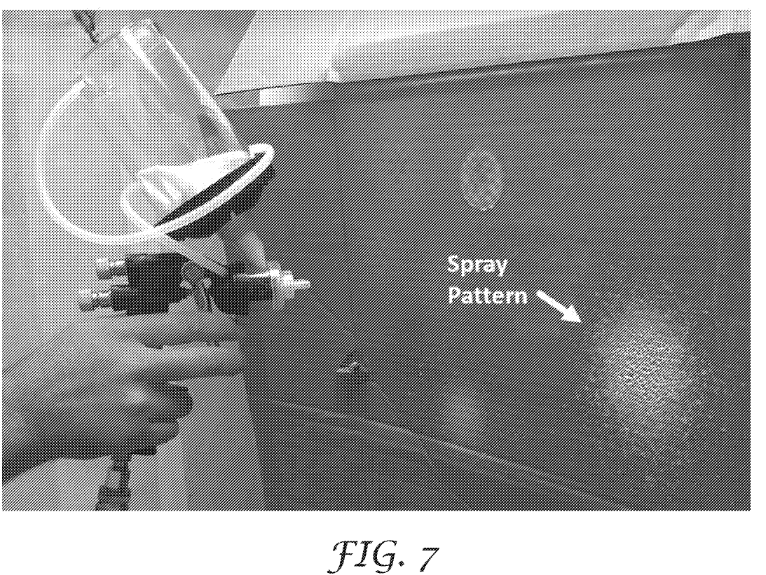

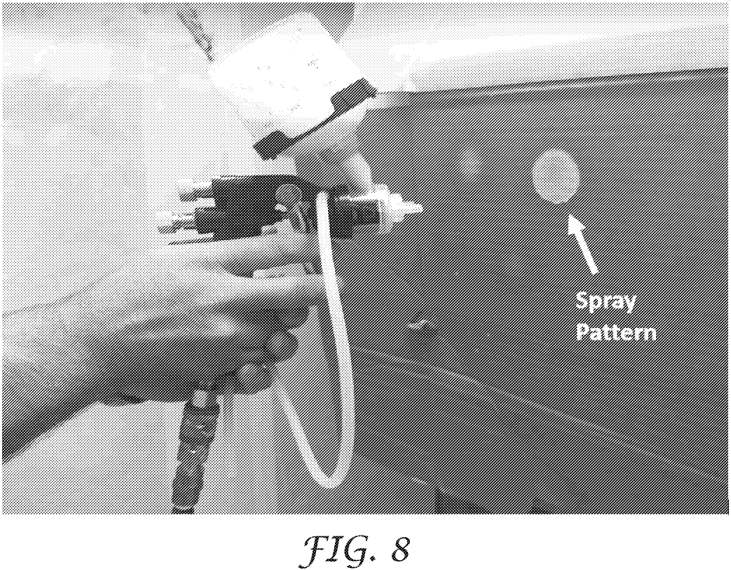

FIGS. 7-8 illustrate atomized polish as described in the Examples herein.

### Example 1

The polish used in Example 1 is 3M™ Finesse-it™ Polish K211 (commercially available). Viscosity of the polish is measured using a Brookfield viscometer, RV6 spindle at 10 rpm, 77 deg F +/- 3. The viscosity of the commercially available polish ranges from 38,000 to 45,000 centipoise.

Polish was filled into a 3M Accuspray 16580 spray system. An Accuspray disposable liner was used inside of the supply chamber. A supply pressure of 9 psi was applied to the supply chamber to at least partially compress the disposable liner and enable passage of the polish to the nozzle. The same back pressure of 9 psi was applied to the spray nozzle. By compressing the trigger, a spray pattern of the polish was applied to a vertical surface from a distance of 4 inches away. The spray slightly atomized and struggled to progress through the nozzle. The shape of the sprayed pattern was not well defined or consistent. The resulting spray pattern can be seen in FIG. 7.

### Example 2

A polish was made in the lab using the same formulation as 3M™ Finesse-it™ Polish K211, but without the addition of the viscosity modifier. The viscosity of the polish was measured using a Brookfield viscometer, LV2 spindle at 30 rpm, 71 deg F and found to be 351 centipoise.

The same conditions were applied for spraying as in Example 1, however, a disposable liner was not necessary as the polish easily supplied itself to the nozzle without the need for an applied back pressure. The spray pattern had substantially finer atomization and a much more defined circular shape. The resulting spray pattern can be seen in FIG. 8.

1. A polish dispensing system for a robotic repair unit.
a polish container filled with a low viscosity polish;
a polish dispenser associated with a robotic repair unit;
a coupler that connects the polish container to the fluid dispenser; and
a mounting mechanism configured to couple the polish container to a robotic repair unit.

2. The polish dispensing system of claim 1, wherein the polish dispensing system is self-contained on the robotic repair unit.

3. (canceled)

4. The polish dispensing system of claim 1, and further comprising: a pump and a motor configured to drive the pump.

5. (canceled)

6. The polish dispensing system of claim 1, and further comprising an air source coupled to the polish container and - wherein the polish dispenser is a pneumatic polish dispenser.

7. (canceled)

8. The polish dispensing system of claim 1 , wherein the polish container and the coupler are disposable.

9. (canceled)

10. (canceled)

11. The polish dispensing system of claim 1, wherein the polish container changes volume as the low viscosity polish is dispensed.

12. The polish dispensing system of claim 1, wherein the polish dispensing system is mounted such that gravity provides some of the pressure needed for polish to flow from the polish container to the dispenser.

13-16. (canceled)

17. The polish dispensing system of claim 1, wherein the coupler comprises a fluid line.

18. (canceled)

19. The polish dispensing system of claim 1, wherein the polish container is configured to be mounted on a tool side of a force control unit.

20. The polish dispensing system of claim 1, and further comprising a sensor for detecting a low fluid level, wherein the sensor comprises a weight sensor, an optical sensor, or a volumetric sensor.

21. The polish dispensing system of any of claim 20, wherein the weight sensor is a force control unit of the robotic repair unit.

22. The polish dispensing system of claim 1, wherein the low viscosity polish has a viscosity below 10,000 cp.

23. (canceled)

24. The polish dispensing system of claim 1, wherein the low viscosity polish is free of wax compounds.

25-34. (canceled)

35. A method of replacing a polish source on a robotic repair system, the method comprising:
detecting, using a first sensor, a polish level has reached a replacement fluid level in a used polish source;
removing the used polish source;
installing a new polish source; and
detecting, using a second sensor, the new polish source is installed.

36. The method of claim 35, wherein the first sensor is a weight sensor that detects a weight of the used polish source indicative of the replacement polish level.

37. The method of claim 36, wherein the weight sensor is a force control unit of the robotic repair sytem.

38. The method of any claim 35, and further comprising: detecting a polish type associated with the new polish source and providing the detected polish type to a controller associated with the robotic repair unit.

39. A robotic repair unit comprising:
a robotic arm with a force control coupled to an end effector containing an abrasive tool; and
a self-contained fluid dispensing system configured to dispense a low viscosity polish on a worksurface, wherein the self-contained polish dispensing system comprises:
a dispenser; and
a polish container coupled to the dispenser, and wherein the polish container is mounted to the robotic repair unit.

40. (canceled)

41. (canceled)

42. The robotic repair unit of claim 39, wherein the polish container is mounted on a tool side of a force control unit of the robotic arm.

43. The robotic repair unit of claim 42, wherein the force control detects a change in weight of the polish container corresponding to a low fluid level.
